(19) United States
(12) Patent Application Publication
(10) Pub. No.: US 2008/0265017 A1
(43) Pub. Date: Oct. 30, 2008

(54) Credit card and security system

(76) Inventor: Sammie J. West, Rochester, NY (US)

Correspondence Address: Law Office of Alfred Hoyte;Ste. 500, 1101 30th St. NW, Washington, DC, 20007, US

(21) Appl. No.: 11/585,340

(22) Filed: Oct. 24, 2006

(51) Int. Cl. G07F 19/00

(52) U.S. Cl. 235/379; 235/380

(57) ABSTRACT

A personal banking card that uses a fingerprint reading system on the back of the card that is used to read a particular individual's finger print and match that information with the finger print information contained in the memory storage system of the card. The card also has two electronic storage means on the back of the card that may be micro chips or some similar means. The storage system is used to store both information relating to the user's bank account number, the balance in the account as well as information relating to finger print information of the owner of the card. There is a means to communicate between the two storage means in order that a signal can be given from one to the other in order to “unlock” the account and allow charges to be made by using the card. When the card has been “unlocked” via the security feature, the card is active and merely swiping it or otherwise using it will cause charges to be paid and the amount deducted from the account balance stored on the card.

### FIELD AND BACKGROUND OF THE INVENTION

The invention relates to the field of electronic banking transactions and, in particular, to a card based system that stores personal information relating to an individual user's particular bank account and personal identification information relating to the owner of the card. The card also includes a means to read a fingerprint from the owner of the card and compare it to information stored in the memory storage medium of the card.

In the modern era, the trend in banking and credit card businesses has been to use electronic means in order to facilitate the exchange of money. Typically a user inserts a plastic card (automated teller machine or ATM) card that has information stored upon a magnetic strip or some other type of electromagnetic means in connection with the card. We may use the term “banking card” to loosely refer to this broad category of plastic cards with electromagnetic type of storage means associated with them. The invention described herein will dispense with the need to use ATM machines to get the cash as the card itself will keep a running account balance on a chip that is embedded in the card.

In the current state of the art, such information storage means is a magnetic strip on one side of the card and typically the card is used by swiping the strip across some sort of reading device that reads the information that is associated with the card. Typically such information would pertain to the account number of the owner of the card, his/her password and other such information. These cards are in wide spread use in the modern day and those skilled in the art will readily grasp the types of cards being described and how they work and how they are used.

The information storage strip typically has information pertaining to the user such as his password stored in the strip and this information is used to interact with the ATM in order to identify the user by matching the information stored on the strip with information that the user inputs into the machine. Thus the information storage means allows the owner of the card to access the machine without the danger that someone will steal the card and withdraw money for himself.

Included in these transactions are the necessary means on the magnetic strip to identify the owner of the card since face to face interactions are not used with the card. The invention described herein is designed to facilitate such faceless interactions by making available the user's particular identifying information (such as fingerprints) in the form of a small information storage means that is in connection with the banking card itself.

It is thought that this invention would have greatest usage would be as a credit card since the card can be used to charge bill and/or dispense cash to the user as the account balance is held right on the card. It is thought that both banking and credit card transactions could use this technology since they both relate to maintaining accounts with funds in them and they often use the same type of technology in connection with ATM machines. There are likely many other type of financial transactions that may find use with the type of cards described in the present invention.

### SUMMARY OF THE INVENTION

As described and shown in more particularity below, the card uses a fingerprint reading system on the back of the card that is used to read a particular individual's finger print and match that information with the information contained in the memory storage system of the card. The card also has two micro chip or similar type of means on the back of the card that is used to store a) information relating to the bank account including the account number and the balance in the account as well as b) information relating to finger print or other personal identifying information of the owner of the card. There is a means to communicate between the two microchips in order that a signal can be given from one to the other in order to “unlock” the account and allow charges to be made by using the card. When the card has been “unlocked” via the security feature, the card is active and merely swiping it or otherwise using it will cause charges to be paid and the amount deducted from the account balance stored on the card.

It is an object of the invention to provide a unique electromagnetic based card with electronic storage medium that will have at least two storage means for storing both personal identification information and bank account information including the account balance on the back of the card.

It is another object to provide a electromagnetic based card that can use an electronic storage medium that can access information on the card pertaining to particular identification information that is personal to the individual that owns the card.

It is another object of the invention to provide an electromagnetic based card that will have a finger print reading means in connection with one side of the card that can scan the finger print of an individual and compare this information to stored information on the card and verify whether or not the fingerprint information matches that stored on the card.

Other objects of the invention will be apparent to those skilled in the art once the invention is shown and described.

### DESCRIPTION OF DRAWINGS

FIG. 1 shows the overall construction of the back of the card;

FIG. 2 shows the overall construction of the front of the card.

### DESCRIPTION OF THE PREFERRED EMBODIMENT

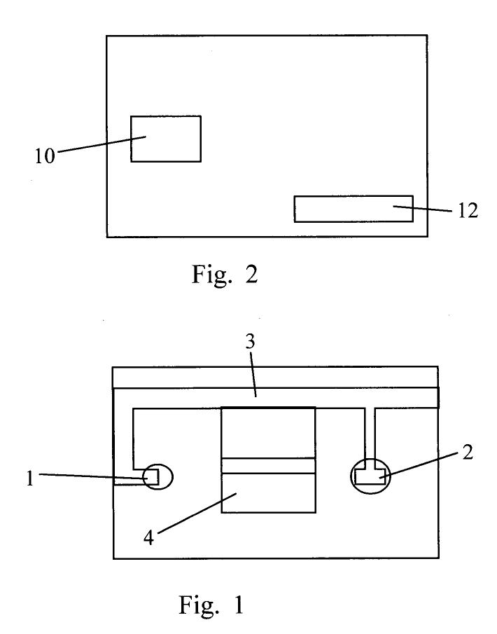

As shown in FIG. 1, there is on the back of the card at least two separate sites for the placement of electronic means to store data relating to information, see 1 and 2. These electronic storage sites may be loosely referred to as “chips.” So that chip 1 will be known as the “fingerprint chip” and the other is known as the “bank account chip” or “account chip” 2. (It does not matter which chip is on the left or the right, they can be in either place). On the finger print chip, there will be information pertaining to a particular user's identifying information. It is preferred that this information be relating to the user's finger print information. It is also possible that other personal information may be used such as the structure of the user's blood vessel system in their eye. On the other chip, the account chip, will be information stored relating to the person's bank account. This would include for example his bank account number and the amount of money in the account.

Because the balance in the account is recorded right on the card, via the chip, there is no need to go to an ATM machine in order to get cash. The card will act as a ready source of cash in effect. The card can be used in at least two manners: as a typical credit card (but where the charge is immediately deducted from the user's bank account) or as a sort of cash card that can dispense cash to the owner by interaction with a bank machine. Again the charge will be immediately deducted from the user's account balance since that information is carried directly on the card and is stored in the memory of the card. In both of these methods the card needs to first become “active” by interacting with the individuals finger print or eye ball blood vessel or some such personal identifying means.

FIG. 2 shows the front of the card which can be of a more conventional appearance (e.g. a bank card or credit card) although in this particular case it is preferred that there be some sort of photo 10 or other means to identify the face of the owner of the card. It is preferred that the front face of the card have this photo but it is not believed to be necessary to the function of the novel means that is being claimed. No. 12 in FIG. 2, represents the banking company logo or some other insignia and is not necessary for the invention to function.

When the card is to be used, the user must first activate the card by applying a finger tip to the finger print reading means 4 as seen in FIG. 1. This means will read the fingerprint and compare it to information stored in the card at the finger print chip 1. If there is a successful match, the account is activated and a message is sent from chip 1 to chip 2 via the transmission means 3. This means for transmitting the message can be any state of the art means and would likely be electromagnetic in nature. When the account is active it will allow the card to be swiped or otherwise interact with a machine (such as a credit card swiping machine or an ATM machine or something similar) and money will be deducted right from the user's bank balance that is kept up to date on chip 2.

The interaction could be by any state or the art type of machine that can read magnetic strips and similar types of information storage means. In fact there could be another magnetic strip on the present invention in order to allow the transaction to be completed via interaction with a machine. The card could be used to either pay a charge or actually dispense cash to the card owner. In either case, the card is first activated by a successful match through the finger print scanner and the card becomes active. The active card can then be inserted into another machine so that the account holder information can be obtained. Such as the name, the number of the account and the amount of the charge.

This amount of the charge will be deducted from the balance total that is held on the chip 2. In this manner a running account balance is maintained on the card at all times without having to go to the bank to verify this or to put more money on the card.

When the card is activated the card will be swiped or other wise passed through a reader in another machine that will read the information contained in the card. The machine will know from the card the user account information. The card could be inserted into an ATM machine in order to dispense cash to the owner. The same process would take place, the card is first activated, then it is passed into the ATM machine. The ATM machine reads the necessary information and dispenses the cash, the card in turn will deduct this amount from the running balance that it keeps. There would be a means on the card that can obtain the amount of the charge from the machine and use this amount to deduct it from the balance.

Also on the back of the card will be a finger print reading means 4 that will preferably be between the two chips. The device will absorb heat from the person's finger in order to activate the finger print reading means. This device will be able to read a fingerprint of an individual and compare this information to stored information that is stored in the “finger print” chip 1 on the card.

This information will be compared to see if the information stored in the card matches the finger print of the individual who has scanned his finger print across the finger print reading means of the card. If the information that is scanned by the reading means matches the stored information in the card then the finger print chip will send a message via the communications link 3 to the account chip 1. The account chip will then allow the card to be activated and money can be deducted from that person's account. The account chip will change the balance that it is crediting for the owner. So if the user wants to charge a $10 bill, he activates the card, then swipes it other wise interacts with a machine that records the $10 charge and the account chip will then deduct $10 from the balance that it has in stored memory.

It is thought that it would be best if there is an electronic connecting means between the two chips to allow these two memory storage areas to communicate with one another and thereby transfer information from and to each chip. Other means of reading the user's personal identification may be used without varying from the spirit of the invention. It is possible that there may be a means for reading the persons blood vessels in place of item 4 in the drawings. This would then compare it to the blood vessel system stored in the card and then the card would be activated in the event of a match. Other means for discerning individual user's particular personal characteristics may be used without varying from the spirit of the invention.

I claim:

1. A personal banking card having a means to sent and retrieve information when used in association with an ATM machine; said banking card having at least two micro chip based information storage means on one side of said card, a first said microchip based means having a means to electronically store information pertaining to a particular bank account associated with a user, the account balance and identifying both the account and the user, a second microchip based means for storing and comparing personal finger print information based upon fingerprint information pertaining to said user; a fingerprint reading means in connection with said card, said fingerprint reading means having a means for allowing a finger print to be scanned and for identifying current information relating to the finger print that was scanned, and having a means to read and store said current information, said card having a means to compare said current information with said personal finger print information and in the event of a match between the current finger print information and said stored finger print information of sending a signal from said second micro chip to said first micro chip that will allow said second micro chip to be active, said card having a means for deducting a charge from said account balance that is stored on said second micro chip.

2. The apparatus of claim 1 wherein said first microchip based means has a means to store information pertaining to a password associated with said owner of said card.
